(19) United States
(12) Patent Application Publication
(10) Pub. No.: US 2019/0070595 A1
(43) Pub. Date: Mar. 7, 2019

(54) CATALYST CONTAINING PHOSPHATED KAOLIN AND ALUMINA FROM ACH AND METHOD OF USING THE SAME

(71) Applicant: INAERIS TECHNOLOGIES, LLC, Pasadena, TX (US)

(72) Inventors: Gregory Alan PEARSON, Seabrook, TX (US); Stephany GARCIA, Seabrook, TX (US)

(21) Appl. No.: 16/084,520

(22) PCT Filed: Mar. 21, 2017
(86) PCT No.: PCT/US2017/023416

§ 371 Date: Sep. 12, 2018

Related U.S. Application Data
(60) Provisional application No. 62/312,421, filed on Mar. 23, 2016.

(51) Int. Cl. B01J 29/40; B01J 35/10; B01J 35/00; B01J 21/04; B01J 21/16; B01J 6/00; B01J 37/28; C10G 1/02

(52) U.S. Cl. CPC B01J 29/40; B01J 35/1014; B01J 35/1019; B01J 35/0026; B01J 35/0006; C10G 2300/1011; B01J 21/16; B01J 6/008; B01J 37/28; C10G 1/02; B01J 2208/0069; B01J 21/04

(57) ABSTRACT

A catalyst for use in the thermocatalytic conversion of biomass contains alumina from aluminum chlorohydrate, phosphated kaolin and a calcined phosphated zeolite ZSM-5. The catalyst may be prepared by adding a slurry of particles of the calcined phosphated zeolite ZSM-5 to phosphoric acid and kaolin and then adding to the resulting product the aluminum chlorohydrate. The particles are then spray dried and calcined.

### FIELD OF THE DISCLOSURE

The disclosure relates to a zeolite containing catalyst for use in the conversion of biomass to bio-oil. The catalyst contains alumina derived from aluminum chlorohydrate, phosphated kaolin and a calcined phosphated zeolite ZSM-5.

### BACKGROUND OF THE DISCLOSURE

Renewable energy sources, such as biofuels, provide a substitute for fossil fuels and a means of reducing dependence on petroleum oil. In light of its low cost and wide availability, biomass is often used as a feedstock. Renewable biofuels may be produced by subjecting the biomass to catalytic thermolysis or pyrolysis. The liquid product resulting from catalytic thermolysis separates into an aqueous phase and an organic phase. The organic phase containing bio-oil, char, coke and ash. Upon being separated from the organic phase, the bio-oil can be converted to liquid hydrocarbon fuels.

Typically, heavy materials and solids along with unwanted carbonaceous deposits, such as coke, are formed during the thermocatalytic conversion of biomass into bio-oil. These materials typically plug the pores of the catalyst which reduces the activity of the catalyst and lowers the stability of the catalyst. The reduced activity of the catalyst, in turn, results in reduced yields of produced bio-oil.

Accordingly, there remains a need for a catalyst for the thermocatalytic conversion of biomass which exhibits higher activity than the catalysts of the prior art and which provides higher bio-oil yields.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

### SUMMARY OF THE DISCLOSURE

The disclosure relates to a catalyst for converting biomass into bio-oil. The catalyst contains alumina from aluminum chlorohydrate, phosphated kaolin and calcined phosphated zeolite ZSM-5.

In an embodiment, an alumina containing catalyst for converting biomass into bio-oil is provided. The catalyst contains alumina from aluminum chlorohydrate, phosphated kaolin; and calcined phosphated zeolite ZSM-5. Between from about 5 to about 15 weight percent of the alumina in the catalyst is from the aluminum chlorohydrate.

In another embodiment of the disclosure, a catalyst is provided wherein the catalyst is composed of particles containing alumina from aluminum chlorohydrate, phosphated kaolin and calcined phosphated zeolite ZSM-5. Between from about 1 to 10 volume percent of the catalyst particles have a diameter between from about 20 to about 39 μm, from about 35 to about 55 volume percent of the particles have a diameter between from about 40 to about 80 μm and between from about 35 to 55 volume percent of the particles have a diameter between from about 81 to about 150 μm.

In another embodiment, a method is provided of preparing a catalyst containing alumina (from aluminum chlorohydrate), phosphated kaolin and a calcined phosphated zeolite ZSM-5. The phosphated kaolin contains P₂O₅ and is prepared by reacting kaolin with phosphoric acid. The catalyst is prepared by mixing the phosphated kaolin with a slurry containing the calcined phosphated zeolite ZSM-5. Aluminum chlorohydrate is then added to the reaction mixture. The product is subjected to spray drying and shaped. The catalyst is then calcined. The amount of P₂O₅ in the catalyst is between from about 5 to about 20 weight percent, based on the total weight of the catalyst.

In another embodiment of the disclosure, a method of enhancing the yield of bio-oil from biomass is provided. In this method, biomass is subjected to thermolysis in a biomass conversion unit in the presence of a catalyst. The catalyst contains alumina (from aluminum chlorohydrate), phosphated kaolin and calcined phosphated zeolite ZSM-5.

Accordingly, the present disclosure provides a catalyst, a process of making the catalyst and a process of converting biomass into bio-oil in the presence of the catalyst.

Characteristics and advantages of the present disclosure described above and additional features and benefits will be readily apparent to those skilled in the art upon consideration of the following detailed description of various embodiments.

### DETAILED DESCRIPTION OF THE PREFERRED EMBODIMENTS

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Further, whenever a numerical range with a lower limit and an upper limit are disclosed, any number falling within the range is specifically disclosed.

As used herein, the term “catalyst” refers to particle(s) which provide catalytic functionality.

The biomass conversion catalyst(s) described in the embodiments below can comprise, consist of, or consist essentially of alumina (originating from aluminum chlorohydrate), phosphated kaolin and calcined phosphated zeolite ZSM-5.

The phosphated kaolin contains P₂O₅ and may be prepared by reacting kaolin with phosphoric acid. Typically, the wt. ratio of kaolin:phosphoric acid used in the reaction is between from about 2.4:1 to about 4.2:1, preferably from about 2.7:1 to about 3.8:1. The phosphoric acid is typically 57 wt. % or 85 wt. %. The amount of P₂O₅ in the catalyst is typically between from about 6 to about 20 weight percent, based on the total weight of the catalyst. In an embodiment, the amount of P₂O₅ in the catalyst is between from about 9 to about 16 weight percent, based on the total weight of the catalyst.

The calcined phosphated zeolite ZSM-5 may be prepared by treating ZSM-5 zeolite with a phosphorus-containing compound at temperatures ranging from about 20° C. to about 30° C., or about 25° C., for about 10 minutes to about 24 hours. The dry weight ratio of phosphorus-containing compound:zeolite is typically about 1:10. The resulting product is a phosphorus-promoted zeolite component

The phosphorus-containing compound can be any compound containing phosphorus, such as phosphorus oxyacids and organophosphorus compounds. In one embodiment, the phosphorus-containing compound is phosphoric acid (H₃PO₄). The phosphorus-containing compound can be used at a concentration of about 0.01 wt % to about 90 wt %, about 50 wt %, about 60 wt %, about 70 wt %, about 80 wt %, or about 90 wt %, most typically at 57 wt %. The pH during the treatment of ZSM-5 zeolite with the phosphorus-containing compound is typically around 1.5. After forming the phosphorus-promoted zeolite component, the pH may be increased to about 3.5 to about 4.0 by the addition of ammonium hydroxide. The product may then be spray dried. The resulting spherical particles may then be calcined in the presence of air to convert the phosphorus into oxide.

The catalyst typically has an apparent bulk density between from about 0.70 g/mL to about 0.94 g/mL.

The biomass conversion catalyst may be prepared by a method comprising, consisting of, or consisting essentially of:
(a) mixing phosphated kaolin with a slurry of particles of the calcined phosphated zeolite ZSM-5. Typically, the phosphated kaolin on an average contains about 10 wt. % P₂O₅ from the phosphoric acid;
(b) adding the aluminum chlorohydrate as binder to the product of step (a). Without being bound by any theory, it is assumed the aluminum chlorohydrate remains in solution in the presence of phosphoric acid. It is further assumed that a portion of the phosphoric acid reacts with the aluminum chlorohydrate as the number of reactive sites on the kaolin decreases. The pH of the product resulting from the addition of aluminum chlorohydrate to the slurry of step (a) is typically less than 2.5 and more typically less than 1.3. Unlike other zeolites, such as Y-zeolite, the calcined phosphate ZSM-5 does not degrade at such a low pH;
(c) spray drying the product of step (b), typically at an outlet temperature of about 300° F. Without being bound to any theory, it is believed that the aluminum chlorohydrate binds the calcined phosphated zeolite ZSM-5 and phosphated kaolin into particles during the spray drying; and
(d) calcining the product of step (c). The calcining of the spray dried particles can be at a temperature in the range of from about 300° C. to about 600° C., or from about 400° C. to about 550° C. Calcination typically proceeds at a temperature of about 600° C. for about 2 hours.

Typically between from about 1 to 10 volume percent of the catalyst particles have a diameter between from about 20 to about 39 μm, from about 35 to about 55 volume percent of the particles have a diameter between from about 40 to about 80 μm and between from about 35 to 55 volume percent of the particles have a diameter between from about 81 to about 150 μm.

The pore structure of the catalysts can have average pore sizes (diameters) ranging from about 15 to about 50 angstroms.

In another embodiment, the biomass conversion catalyst may comprise, consist of, or consist essentially of between from 8 to about 16 percent by weight (based on the total weight of the catalyst) of alumina from aluminum chlorohydrate; between from about 20 to 55 weight percent, more typically between from about 35 to 50 weight percent, even more typically about 40 weight percent, based on the total weight of the catalyst, of calcined phosphated zeolite ZSM-5; and between from about 30 to about 50 weight percent, typically about 38 weight percent, based on the total weight of the catalyst, of phosphated kaolin.

The average total surface area of the particles of the catalyst is between from about 95 to about 135 m²/g.

Typically, analysis of the catalyst shows the total amount of alumina in the catalyst (originating from the zeolite, kaolin and aluminum chlorohydrate) to be between from about 20 to about 40 percent, more typically from about 25 to about 35 percent. Between from about 5 to about 15 weight percent of the alumina in the catalyst is from the aluminum chlorohydrate.

Analysis of the catalyst shows the amount of SiO₂ in the catalyst (originating from kaolin and zeolite), by weight, is typically between from about 45 to 65 percent, more typically between from about 50 to 55 percent. Between from about 50 to about 70 percent of silica in the catalyst is from the zeolite ZSM-5 of the calcined phosphated zeolite ZSM-5. Further, between from about 30 to about 50 percent of silica in the catalyst is from the kaolin of the phosphated kaolin.

Analysis of the catalyst shows the amount of TiO₂ in the catalyst (originating from kaolin), by weight, is typically between from about 0.05 to 2 percent, more typically between from about 1 to 1.4 percent.

Catalysts prepared according to the methods described herein can be used in the conversion of biomass to bio-oil and provide improved yield of bio-oil, lower coke deposits and less char compared to conversion processes using conventional catalysts. In some embodiments, the catalyst exhibits improved hydrothermal stability and/or catalytic activity. As used herein, the term “catalyst activity” refers to the amount of biomass converted to bio-oil during the conversion. For instance, the yield of bio-oil may be about 5%, about 10%, about 20%, about 25%, about 30% or about 50% higher than using conventional catalysts. In certain embodiments, the amount of coke and char produced in biomass conversion using catalysts of the present disclosure is about 50% lower than when conventional catalysts are used. In other instances, the amount of coke and char produced may be 30% lower, in some instances about 25% lower and in some instances about 20% lower, than the amount of coke and char produced during biomass conversion in the presence of a conventional catalyst.

In addition, bio-oil produced has a lower amount of oxygen than the bio-oil produced from biomass in the presence of previously used catalysts. It is desirable to decrease the amount of oxygen in the organic phase containing the bio-oil due to the corrosive nature and polymerization tendencies of highly oxygenated hydrocarbonaceous compounds.

As such, certain aspects of the present disclosure relate to a process for treating a biomass with a catalyst comprising an ex-situ phosphorous-activated calcined zeolite and the alumina binder. The use of the disclosed catalyst in the conversion process provides an increase in yield of organic compounds which may be processed into fuel, feedstock, and specialty chemicals. Without limitation, the fuel may be used as heating oil, gasoline, as a feedstock for gasoline blending, as diesel fuel, as a basis for blending a diesel fuel, as jet fuel, as a basis for a jet fuel, as a feedstock for the petrochemical industry, and in connection with other similar uses. Such fuels can have a lower carbon footprint, as compared to purely petroleum based refinery liquids, and such fuels may have a higher heating value than other renewable fuels, such as compared to ethanol/gasoline blends, which may result in increased gas mileage to the consumer.

The biomass material useful in the disclosure described herein can be any biomass capable of being converted to liquid and gaseous hydrocarbons. Preferred are solid biomass materials comprising a cellulosic material, in particular lignocellulosic materials. The solid biomass feed can comprise components selected from the group consisting of lignin, cellulose, hemicellulose, and combinations thereof. Examples of suitable solid biomass materials include forestry wastes, such as wood chips and saw dust; agricultural waste, such as straw, corn stover, sugar cane bagasse, municipal waste, in particular yard waste, paper, and card board; energy crops such as switch grass, coppice, eucalyptus; and aquatic materials such as algae; and the like.

In a preferred embodiment, the catalyst disclosed is used in the thermocatalytic conversion of solid biomass to bio-oil or bio-oil vapor or gas in a fluidized bed reactor. Products of the gaseous phase include carbon dioxide, carbon monoxide, methane, hydrogen, ethane, propylene, butane and butenes.

The reactor in which biomass is converted into bio-oil can be operated at a temperature in the range of from about 200° C. to about 1000° C., or between about 250° C. and about 800° C. The biomass conversion reactor can also be operated in the substantial absence of oxygen.

The vapor conversion products comprise, consist of, or consist essentially of bio-oil and water. At least a portion of the vapor conversion products can be separated from the conversion reactor effluent, and at least a portion of the vapor conversion products thus separated can be condensed to form a condensate comprising bio-oil and water. The condensate is generally separable by gravity separation into the bio-oil and into an aqueous phase comprising water.

Optionally, at least a portion of the bio-oil can be separated from the condensate, also forming the aqueous phase comprising water and less than about 25 wt %, or less than about 15 wt % hydrocarbonaceous compounds. Such separation can be by any method capable of separating bio-oil from an aqueous phase, and can include, but is not limited to, centrifugation, membrane separation, gravity separation, and the like. Preferably, if separated, the condensate is separated by gravity separation in a settling vessel into the bio-oil and into the aqueous phase. The oxygen levels of the produced bio-oils can be less than about 30 wt % on a dry basis, or between about 15 to about 23 wt % on a dry basis.

The attrition loss used herein refers to the catalyst loss due to physical abrasion, attrition, or grinding of catalyst particles during use in catalytic conversion processes. The attrition loss of the catalyst is between from about 0.5 to about 8 weight percent, more typically between from about 1 to about 4 weight percent, ASTM D5757.

The disclosure will be further clarified by a consideration of the following examples, which are intended to be purely exemplary.

### EXAMPLES

All percentages set forth in the Examples are given in terms of weight units except as may otherwise be indicated.

### Example 1

A catalyst containing 14% P₂O₅ as phosphoric acid (H₃PO₄), 38% kaolin, 8% ACH, and 40% of 9% PZSM-5 (ex-situ phosphated) was prepared as follows. 20.0 kg of ZSM-5 zeolite was slurried using 55.64 kg of water. The slurry was then mixed with 4.36 kg of a 57% solution of H₃PO₄ (by weight). The pH of the slurry was adjusted to 4.0 by the addition of ammonium hydroxide. After the slurry had been stirred for 15 minutes, it was spray dried at 300° F. outlet temperature and then calcined at 600° C. for 2 hours. The calcined phosphated zeolite was then slurried to approximately 36% solids content and then milled to a target particle size of 3 μm.

In a separate mix tank, 15.23 kg of water was thoroughly mixed with 6.27 kg of a 57% solution of H₃PO₄ (by weight) at room temperature. This solution had a pH of 0.92. 11.44 kg of kaolin (86% on a dry basis) were slowly added to the H₃PO₄/water solution, and this slurry was mixed for 30 minutes using a mechanical mixer. After 30 minutes, 28.42 kg of the phosphated zeolite slurry of the above paragraph was added to the kaolin mixture generating a slurry with a pH of about 1.05. Then, 8.63 kg of a solution of aluminum chlorohydrate (23.6 wt. % alumina) was slowly added to the reaction mixture. The pH of the slurry rose to 1.91. The contents were then mixed for an additional 15 minutes. The slurry was spray dried at an outlet temperature of 149° C. (300° F.), using a 0.22 nozzle and an approximate pressure of 500 psi. The resulting product was then calcined at 600° C. for 1 hour.

The catalyst was tested according to the methods of Table I. The catalyst was stored in a dessicator between analyses.

TABLE I

| | | |
|---|---|---|
| Attrition by Air Jet, ASTM D5757 | 5.5 | wt % |
| Apparent Bulk Density, ASTM B329 | 0.74 | g/mL |
| Total Surface Area | 116.1 | m²/g |
| Meso Surface Area | 24.9 | m²/g |
| Micro Surface Area | 91.2 | m²/g |
| Average Pore Size | 24.3 | Å |
| Average Particle Size | 87 | μm |
| Fraction of catalyst particles, diameter size, 0-20 μm range | 0 | vol % |
| Fraction of particles in the 20-40 μm range | 1.4 | vol % |
| Fraction of particles in the 40-80 μm range | 40.2 | vol % |
| Fraction of particles in the 80-150 μm range | 52.5 | vol % |
| Fraction of particles in the 150+ μm range | 5.9 | vol % |

The catalyst was analyzed as the stable oxide (e.g., the amount of aluminum in the sample was measured in terms of Al₂O₃) by X-ray fluorescence. The results of the analysis is set forth in Table II:

TABLE II

| | |
|---|---|
| Al₂O₃ content | 29.0% |
| Fe₂O₃ content | 0.4% |
| P₂O₅ content | 14.2% |
| SiO₂ content | 54.7% |
| TiO₂ content | 1.0% |

Prior to introducing the catalyst into the biomass conversion unit, the particles having a diameter size in excess of 150 μm are removed.

While exemplary embodiments of the disclosure have been shown and described, many variations, modifications and/or changes are possible and may be made and used by one of ordinary skill in the art without departing from the spirit or teachings of the disclosure and scope of appended claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A catalyst for converting biomass into bio-oil, the catalyst composed of particles comprising:
(a) alumina derived from aluminum chlorohydrate;
(b) phosphated kaolin; and
(c) a calcined phosphated zeolite ZSM-5.

29. The catalyst of claim 28, wherein the amount of alumina derived from aluminum chlorohydrate in the catalyst is from about 8 to about 16 percent by weight, based on the weight of alumina.

30. The catalyst of claim 28, wherein the amount of calcined phosphated zeolite ZSM-5 in the catalyst is between from 20 to 55 weight percent, based on the total weight of the catalyst.

31. The catalyst of claim 30, wherein the amount of calcined phosphated zeolite ZSM-5 in the catalyst is between from about 35 to 50 weight percent, based on the total weight of the catalyst.

32. The catalyst of claim 28, wherein the amount of phosphated kaolin in the catalyst is between from about 30 to about 50 weight percent, based on the total weight of the catalyst.

33. The catalyst of claim 28, wherein the phosphated kaolin contains P₂O₅ and is prepared by reacting kaolin with phosphoric acid and further wherein the amount of P₂O₅ in the catalyst is between from 5 to about 20 weight percent, based on the total weight of the catalyst.

34. The catalyst of claim 33, wherein the catalyst is prepared by:
(a) mixing the phosphated kaolin with a slurry of calcined phosphated zeolite ZSM-5;
(b) adding the aluminum chlorohydrate to the product of step (a);
(c) drying the product of step (b); and
(d) calcining the product of step (c).

35. The catalyst of claim 34, wherein the pH of the product of step (a) is less than 1.3.

36. The catalyst of claim 35, wherein the pH of the product of step (b) is less than 2.5.

37. The catalyst of claim 28, wherein the amount of alumina in the catalyst by weight is between from 20 to 40 percent.

38. The catalyst of claim 37, wherein the amount of alumina in the catalyst by weight is between from about 25 to about 35 percent.

39. The catalyst of claim 28, wherein the amount of SiO₂ in the catalyst by weight is between from about 45 to 65 percent.

40. The catalyst of claim 28, wherein the amount of P₂O₅ in the catalyst by weight is from about 5 to about 20 percent.

41. The catalyst of claim 28, wherein the apparent bulk density of the catalyst is between from about 0.70 g/mL to about 0.94 g/mL.

42. The catalyst of claim 28, wherein between from about 50 to about 70 weight percent of silica in the catalyst is from the zeolite ZSM-5 of the calcined phosphated zeolite ZSM-5.

43. The catalyst of claim 42, wherein between from about 30 to about 50 weight percent of silica in the catalyst is from the kaolin of the phosphated kaolin.

44. The catalyst of claim 28, wherein between from about 1 to 10 volume percent of the particles have a diameter between from about 20 to about 39 μm, from about 35 to about 55 volume percent of the particles have a diameter between from about 40 to about 80 μm and further wherein between from about 35 to 55 volume percent of the particles have a diameter between from about 81 to about 150 μm.

45. The catalyst of claim 44, wherein the average total surface area of the particles is between from about 95 to about 135 m²/g.

46. The catalyst of claim 44, wherein the attrition of the particles of the catalyst is between from about 0.5 to about 8 weight percent, ASTM D5757.

47. The method of claim 46, wherein the attrition of the particles of the catalyst is between from about 1 to about 4 weight percent, ASTM D5757.

48. A method of enhancing the yield of bio-oil from biomass comprising subjecting biomass to thermolysis in a biomass conversion unit in the presence of the catalyst of claim 28 and converting the biomass to bio-oil.
